(19) United States
(12) Patent Application Publication
(10) Pub. No.: US 2026/0300255 A1
(43) Pub. Date: Oct. 1, 2026

(54) SYSTEMS AND METHODS FOR HIGHLY SCALABLE WATCHES

(71) Applicant: Confluent, Inc., Mountain View, CA (US)

(72) Inventors: Abhishek Arora, Mountain View, CA (US); Arjun Satish, Los Gatos, CA (US); Jonathan Paul Rosenberg, Redmond, WA (US); Yuanchao Yu, Shawnee, KS (US)

(21) Appl. No.: 19/096,326

(22) Filed: Mar. 31, 2025

(51) Int. Cl. G06F 16/23; G06F 16/11

(52) U.S. Cl. CPC G06F 16/2358; G06F 16/128

(57) ABSTRACT

Systems and methods provide for highly scalable real-time watch sessions. A watch server consumes change events from Kafka topics and a snapshot of a current state from a database. The change events and the snapshot are locally cached at the watch server, which removes a need to consume from the Kafka topics and database for every watch subscription of the watch server. The watch server matches the change events to watch subscriptions using a prefix tree that reflects hierarchical subscription filter criteria. The watch server signals a matching watch subscription with a signal that includes a maximum offset associated with the change events. In response to an API call from the matching watch subscription, the watch server provides the change events to the matching watch subscription. Multiple change events including the change event can be aggregated into a batch, which is transmitted as a data stream to a client associated with the matching watch subscription.

### TECHNICAL FIELD

The subject matter disclosed herein generally relates to monitoring for change events within a database. Specifically, the present disclosure addresses systems and methods for monitoring real-time change events within databases using a highly scalable watch architecture.

### BACKGROUND

In the field of distributed data management, the ability to monitor and respond to real-time changes in databases is crucial for maintaining data consistency and providing timely information to users. This capability is particularly important in cloud-based environments, where data is often distributed across multiple regions and accessed by numerous clients simultaneously. As organizations increasingly rely on real-time data processing for applications such as analytics, monitoring, and decision-making, the demand for scalable and efficient data streaming solutions has grown significantly.

Traditional data streaming architectures, such as those utilizing Apache Kafka, are designed to handle large volumes of data by capturing change data capture (CDC) streams from databases like DynamoDB and Azure Cosmos DB. These architectures enable clients to subscribe to data streams and receive updates as changes occur. However, as the number of subscriptions and data streams increases, these architectures face significant scalability challenges.

### BRIEF DESCRIPTION OF THE DRAWINGS

Various ones of the appended drawings merely illustrate examples of the present disclosure and should not be considered as limiting its scope.

FIG. 1 is a prior art diagram illustrating an inefficient watch architecture.

FIG. 2 is a prior art diagram illustrating an inefficient architecture for database consumption of watch snapshots, according to example embodiments.

FIG. 3 is a diagram illustrating an example architecture for providing highly scalable watches, according to example embodiments.

FIG. 4A is a diagram illustrating a simplified prefix tree used in matching, according to example embodiments.

FIG. 4B is a diagram illustrating an example of the simplified prefix tree used in matching.

FIG. 5 is a diagram of a key-value store with an offset index, according to example embodiments.

FIG. 6 is a diagram illustrating an example architecture for highly scalable watches without a separate compacted queue, according to example embodiments.

FIG. 7 is a flowchart of a method for managing real-time data changes and client subscriptions, according to example embodiments.

FIG. 8 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details.

Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Example embodiments provide a watch architecture that scales to support up to, for example, a million simultaneous watch sessions in an efficient manner. The example embodiments comprise a watch server that monitors data changes by integrating with a change data capture (CDC) stream (e.g., via Kafka topics) and by obtaining snapshots from an underlying database. The watch server is configured to cache both the existing state (e.g., a snapshot) and subsequent real-time changes. In some embodiments the snapshot is stored to a local key-value store (e.g., KV store), while the real-time changes are stored in a compacted queue. In some embodiments, the KV store stores both the snapshot and the real-time changes. In these embodiments, the KV store maintains a compacted event queue using database indexing by object identifier and event offset. By caching the snapshot and real-time changes locally in the watch server, data does not need to be retrieved from the database and Kafka topics for each watch subscription.

In some embodiments, the watch server implements an efficient matching mechanism to process client subscriptions. Each subscription specifies a particular data type and filter criteria, and when a change event occurs, an algorithm based on a hierarchical prefix tree is used to rapidly identify and signal those subscriptions that match the change event. Specifically, the hierarchical structure organizes subscriptions based on their filter criteria, such as data kind and attributes. Each node in the prefix tree represents a level of filtering, allowing for quick traversal and matching of events to subscriptions. For example, an event might be filtered first by data kind, then by specific attributes like country or organization. Each node in the prefix tree is associated with condition variables that represent subscriptions waiting for events matching that node's criteria. When an event matches a node, the condition variables are signaled, waking up the relevant watch subscriptions.

Further still, some embodiments provide for transport multiplexing where multiple logical watch sessions are aggregated over a single persistent network connection (e.g., using protocols like gRPC over HTTP/2). This logical multiplexing minimizes the overhead of creating separate connections and data streams for each subscription.

Transport multiplexing also allows for batching and compression of data across multiple subscriptions. By aggregating data streams, the system can optimize network bandwidth usage, reducing latency, and improving the speed of data delivery to clients. Additionally, the ability to handle multiple logical sessions over a single connection enhances scalability by allowing the watch server to support a large number of client subscriptions without a proportional increase in network resource consumption.

In some cases, a system architecture involves deploying at least one Kafka cluster in every region. This significantly contributes to overall operational and computational overhead due to the number of brokers and networking requirements. This setup highlights the importance of optimizing Kafka usage, as any efficiency improvements made on a per-instance basis can lead to a substantial impact across the entire system. As a result, example embodiments provide a technical solution to the technical problem of scaling watches in an efficient and effective manner.

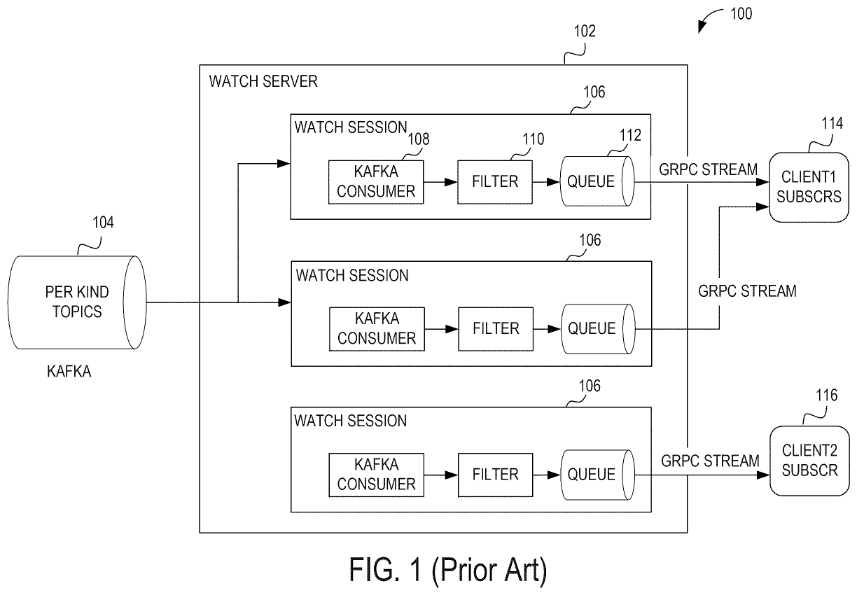

FIG. 1 is a prior art diagram illustrating an inefficient watch architecture 100 that manages watch sessions using Kafka and a watch server 102. Kafka is a distributed event streaming platform that manages topics of different types and is used to handle the ingestion of change data capture (CDC) streams from databases such as DynamoDB and AWS Cosmos. This event streaming platform serves as a source of data streams that are consumed by the watch server 102. In example embodiments, Kafka organizes data streams into topics based on the type or “kind” of data (e.g., per kind topics 104). The per kind topic 104 functions as channels through which data related to specific object types, such as users or addresses, is streamed. Each topic corresponds to a particular kind of data, allowing for organized and efficient data flow.

Kafka interacts with the watch server 102 by providing necessary data streams that the watch server 102 processes and distributes to client subscriptions. The watch server 102 serves as a central component that manages multiple watch sessions 106, each linked to a specific client subscription. The watch server 102 comprises multiple instances of a Kafka consumer 108, a filter 110, and a compaction queue 112, each associated with a different watch session 106 and client subscription.

The Kafka consumer 108 is responsible for consuming data streams from Kafka (e.g., the per kind topics 104). Each Kafka consumer 108 is associated with a specific watch session 106 and processes data for a particular client subscription (e.g., client1 subscriptions 114 or client2 subscription 116). The Kafka consumer 108 ensures that data is received in real-time and passed on to the filter 110 for further processing.

The filter 110 is responsible for applying user-defined criteria to the data streams consumed by the Kafka consumer 108. The filter 110 processes the data based on the user-defined criteria, ensuring that only data matching the user-defined conditions is passed to the compaction queue 112. The predefined conditions are indicated by the corresponding subscription.

The compaction queue 112 stores the filtered data that matches the user-defined criteria specified by client subscriptions. After the Kafka consumer 108 processes data streams from the Kafka topics 104 and the filter 110 applies the necessary criteria, the compaction queue 112 retains only the relevant data.

Once the data is filtered and stored in the compaction queue 112, it is transmitted to the client subscriptions via separate gRPC streams. Each client subscription receives the data that matches its specific criteria. As shown, client1 subscriptions 114 and client2 subscription 116 represent the endpoints that receive data from the watch server 102. Each client can have multiple subscriptions, and the watch server 102 can create separate gRPC streams for each subscription. In the example of FIG. 1, there are two client1 subscriptions 114, each having a separate gRPC stream, while there is only a single client2 subscription 116 that has a gRPC stream.

The watch architecture 100 of FIG. 1 exhibits several opportunities for optimization to enhance scalability and performance. First, there is fan out. The watch architecture 100 creates a separate Kafka consumer 108 for each subscription, which can lead to excessive consumption of data streams from Kafka. For example, 100 watch sessions for the same kind will pull the data 100 times form Kafka. This results in high network costs and increased load on Kafka brokers, as each and every Kafka consumer 108 for those 100 watch sessions reads the entire data stream even if only a portion is relevant to a specific subscription.

A second problem is subscription matching. The watch architecture 100 uses coarse subscription matching, where data is consumed based on per-kind topics but filtered at the subscription level in the watch session 106. This can lead to wasteful data consumption, as the entire topic is read even if only a subset of the data matches the subscription criteria.

The fan out and the subscription matching issues result in a high load on Kafka brokers. This high load further results in increased resource consumption and potential bottlenecks as the Kafka brokers must manage multiple Kafka consumers 108 simultaneously.

Additionally, the watch architecture 100 suffers from inefficient transport. The watch architecture 100 establishes separate gRPC streams for each client subscription, resulting in high overhead in terms of flow control and network resources. This approach increases the complexity of managing multiple streams and can lead to queuing delays at s gRPC layer.

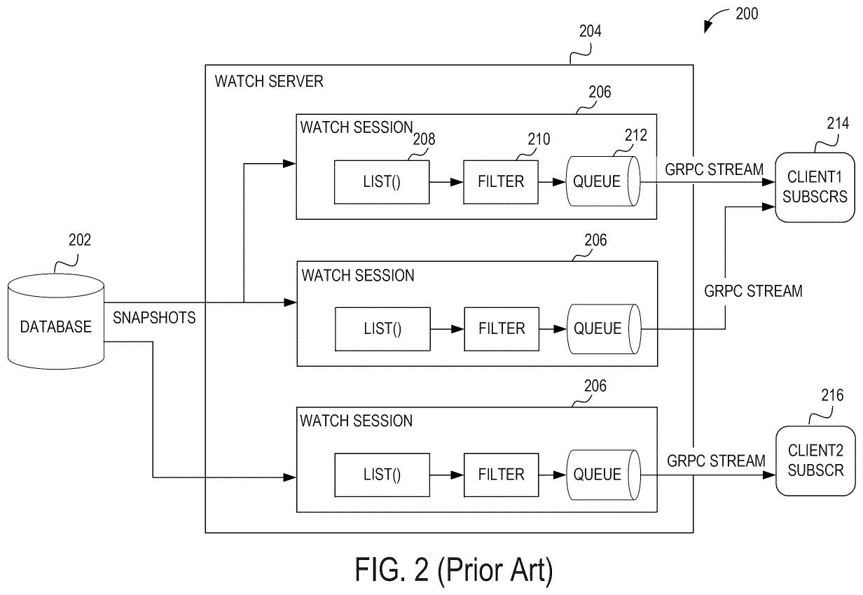

FIG. 2 is a diagram illustrating an inefficient architecture 200 for database consumption of watch snapshots, according to example embodiments. A watch snapshot provides a state of data streams at a specific point in time. When a watch session is initiated, a snapshot of the current state of the data from the database can be captured. This snapshot serves as a baseline for monitoring subsequent changes or events.

A database 202 (e.g., DynamoDB, Cosmos, or Spanner) is responsible for maintaining a persistent state of objects that are subject to watch sessions. The database 202 provides an initial snapshot of data that is required when a watch session is initiated.

This snapshot represents a current state of objects at the time the watch session begins and serves as a baseline for monitoring subsequent changes or events. The database 202 interacts with a watch server 204 by supplying this snapshot data, which is then processed and filtered according to the specific requirements of each client subscription.

The watch server 204 is responsible for orchestrating the flow of data between the database 202 and client subscriptions. The watch server 204 receives the snapshots from the database 202 and processes them in watch sessions 206. The watch server 204 is configured to handle multiple watch sessions simultaneously, each corresponding to different client subscriptions.

A watch session 206 is a logical construct within the watch server 204 that represents an active monitoring session for a specific set of data. Each watch session 206 is associated with a particular client subscription and is responsible for maintaining the state of the data being watched. The watch session 206 utilizes a list( ) 208 to establish a connection with the database 202 and retrieve the necessary snapshot of the current state of data, which can then be processed or monitored for changes.

A filter 210 is a component within the watch session 206 that processes the snapshot data retrieved from the database 202. The filter 210 applies specific criteria to the data to ensure that only relevant information is passed on to client subscriptions 214 and 216.

A compaction queue 212 is a data structure within the watch session 206 that stores the filtered data before transmission to the client subscriptions. The compaction queue maintains the most recent state of the data, ensuring that only the most recent data are sent to the clients.

The client subscriptions (client 1 subscriptions 214 and client 2 subscription 216) represent endpoints of the data flow within the architecture 200. Each client subscription is associated with a specific watch session 206 and receives data that has been filtered and compacted according to the particular requirements of the subscription. The client subscriptions 214, 216 utilize GRPC streams to receive real-time updates from the watch server 204.

The architecture 200 shown in FIG. 2, also exhibits several opportunities for optimization to enhance scalability and performance. First, there is fan out from the database 202. Each subscription snapshot leads to a list( ) on the database 202. If multiple subscriptions match the same data, the same object is read multiple times from the database 202. This results in high database load. Additionally, throttling problems may occur.

Throttling occurs when a system (e.g., the architecture 200) intentionally limits a rate at which data is processed or transmitted to prevent overwhelming resources. In the context of FIG. 2, throttling can be a response to high data volumes or excessive client requests that exceed the watch server's capacity to handle them efficiently. This can lead to delays in data delivery, as the watch server 204 must queue or slow down the processing of data to maintain stability. These problems can also significantly impact the efficiency and scalability of the watch server 204.

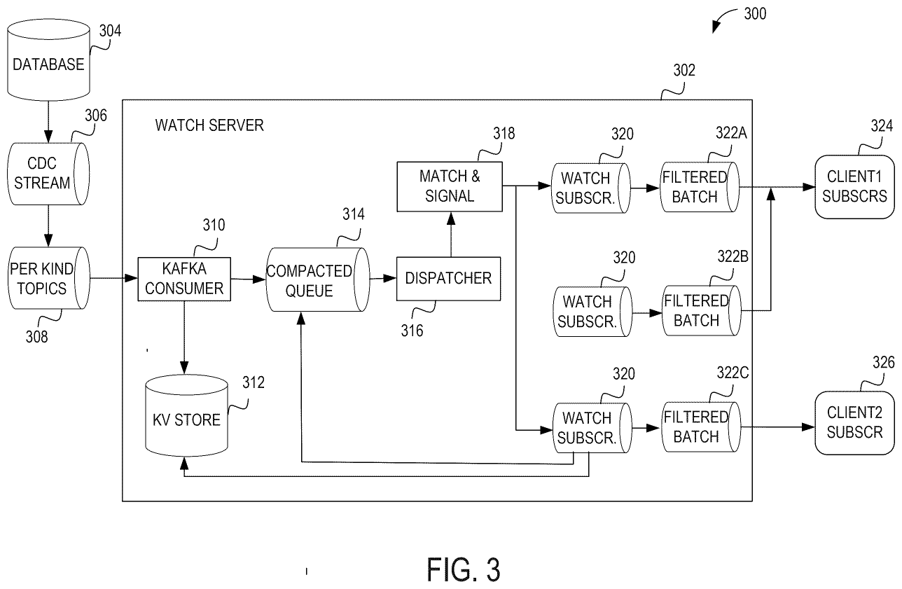

FIG. 3 is a diagram illustrating an example architecture 300 for providing highly scalable watches, according to example embodiments. In example embodiments, a watch server 302 is designed to efficiently manage and distribute real-time data changes to a plurality of client subscriptions in a highly scalable manner.

A database 304 (e.g., Dynamo, Cosmos, Spanner) serves as the primary data source, where changes in data are captured and streamed through a Change Data Capture (CDC) stream 306. This CDC stream 306 ensures that any modifications, such as inserts, updates, or deletes, are captured in real-time. This real-time data is important for the components in the watch server 302, as it forms the basis for generating events that are processed and distributed to clients.

The CDC stream 306 feeds into per kind CDC event topics 308, which organize the data changes by type or kind. Because each topic corresponds to a particular kind of data, it facilitates efficient data segregation and processing within the watch server 302.

Within the watch server 302, a single Kafka consumer 310 is configured to consume data from the per kind CDC events topics 308. The Kafka consumers 310 is designed to handle all kinds of topics. Thus, the Kafka consumer 310 consumes real-time (change) events from the per kind CDC events topic 308.

The KV store 312 functions as a local storage solution for the watch server 302 that offers a fast and efficient method to store and retrieve data. The KV store 312 is used to cache snapshots, enabling the watch server 302 to provide data to clients without repeatedly accessing the primary database 304. This significantly reduces the load on the primary database 304 by allowing the watch server 302 to serve data from the KV store 312 (e.g., local cache) whenever feasible.

In an alternative embodiment, the snapshots can be created and stored to an object storage service (e.g., Amazon S3) and upon request, be streamed from the object storage service. In some cases, the KV store 312 comprises the object storage service. The Kafka consumer 310 also provides data to a compacted queue 314. The compacted queue 314 is a specialized data structure designed to store the most recent state of objects, while maintaining an infinite history of changes. The compacted queue 314 ensures the most recent data can be accessed without having to process the complete history of changes. In example embodiments, the compacted queue 314 compacts multiple versions of a given object, retaining only the most recent version to optimize storage and retrieval. Thus, as change events occur, they are written to the compacted queue 314, which maintains a record of these changes in a compacted form. The compacted queue 314 can also track offsets associated with each change event, which enables efficient retrieval and processing of data changes based on a client's current offset. When change events come in, the compacted queue 314 provides a notification of a current offset (e.g., maximum offset) and metadata.

A subscription dispatcher 316 is configured to manage data change distribution to suitable watch subscriptions. The subscription dispatcher 316 aligns incoming data changes (e.g., change events) with the relevant subscriptions to ensure that each client receives the data they are interested in based on their subscription criteria.

In example embodiments, the subscription dispatcher 316 interacts with a subscription matching and signaling component 318 to determine which subscriptions are relevant for each change event. The matching and signaling component 318 is responsible for evaluating incoming change events against the subscription criteria defined by clients.

In example embodiments, the matching and signaling component 318 uses a hierarchical structure, such as a prefix tree, to efficiently match events to subscriptions. The prefix tree will be discussed in more detail below.

Each watch subscription 320 represents individual subscriptions created by clients to monitor specific data changes. Each watch subscription 320 is associated with a set of criteria that defines the data the client is interested in. The watch subscription 320 is responsible for maintaining a state of each subscription, including a current offset. The current offset in the watch subscription 320 refers to a marker or pointer that indicates a position in the data stream from which the watch subscription 320 last retrieved events.

When a watch subscription 320 is initiated, the watch subscription 320 begins by obtaining a snapshot of the current state of the data from the KV store 312. The KV store 312 stores these snapshots locally, allowing the watch subscription 320 to access the most recent data without needing to query the primary database 304 repeatedly. The snapshot provides a baseline for the watch subscription 320, representing the state of the data at the start of the monitoring session.

After the initial snapshot is retrieved, the watch subscription 320 continues to monitor for real-time change events. Each watch subscription 320 maintains its current offset, which indicates the point in the data stream from which it last retrieves events. As new change events occur, the subscription matching and signaling component 318 notifies matching watch sessions of a latest position of the relevant change events. Given the current offset in the watch subscription 320 and an indication of a maximum offset, the watch subscription 320 can retrieve the change events from the compacted queue 314 using an API call that includes their current offset (e.g., GetObjects(from_offset=current_offset). As a result, the dispatcher 316 can return change events from the current offset to the maximum offset. In the example shown in FIG. 3, only a top and bottom watch subscription 320 match and thus, receive the change events.

A filtered batch 322 is configured to group change events that match specific subscription criteria before they are sent to clients. Initially, the retrieved data can be filtered on specific subscription criteria to ensure only relevant data is delivered to the client. The filtered results are then batched. The batching process allows the watch server 302 to optimize data transmission by reducing the number of individual messages sent over the network.

Client1 subscriptions 324 and client2 subscription 326 represent sets of subscriptions created by two different clients. Each set of subscriptions is managed independently, allowing each client to receive the data they are interested in. In example embodiments, the clients 324, 326 receive data updates through multiplexed streams, which allow for efficient batching and compression of data, optimizing a data transfer process.

For example, client1 subscriptions 324 receives a multiplexed stream that combines logical data streams from filtered batch 322A and filtered batch 332B. Each watch event in the multiplexed stream is tagged with a subscription identifier (ID), allowing client1 to demux the subscriptions based on the subscription ID.

The architecture 300 of FIG. 3 provides several improvements over the architectures discussed in FIG. 1 and FIG. 2 that allow for high scalability and efficiency. First, the architecture 300 provides efficient data consumption by using the single Kafka consumer 310. The Kafka consumer 310 consumers per watch server 302 for all kinds of topic as opposed to conventional architectures (e.g., architecture 100 of FIG. 1) that consume per subscription. Additionally, only a single database list (e.g., current snapshot) is needed per watch server 302 versus conventional architectures (e.g., architecture 200 of FIG. 2) that consume per subscription. This, in turn, minimizes load on Kafka (e.g., Kafka brokers) and the database 304.

Secondly, the architecture 300 of FIG. 3 allows for efficient fanout from within the watch server 302. For example, the snapshots are served from the local KV store 312 instead of being retrieved for every subscription from the database 304. Furthermore, real time change events are served from the compacted queue 314 instead of from Kafka for every subscription.

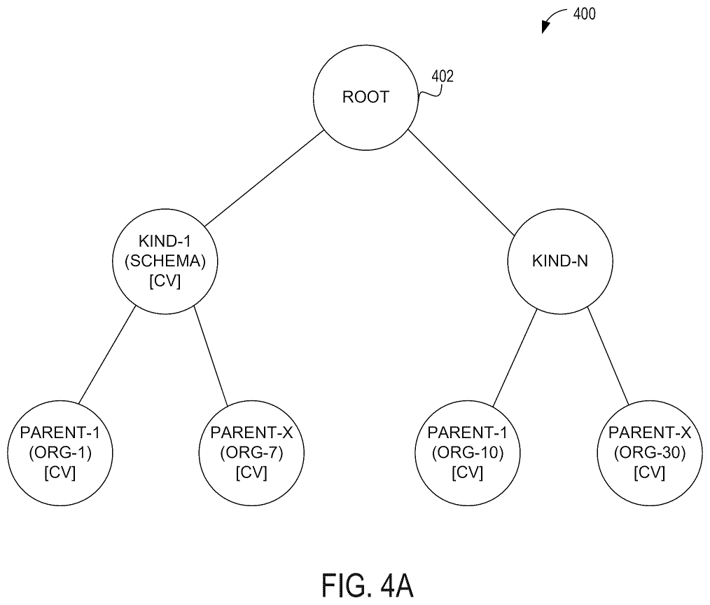

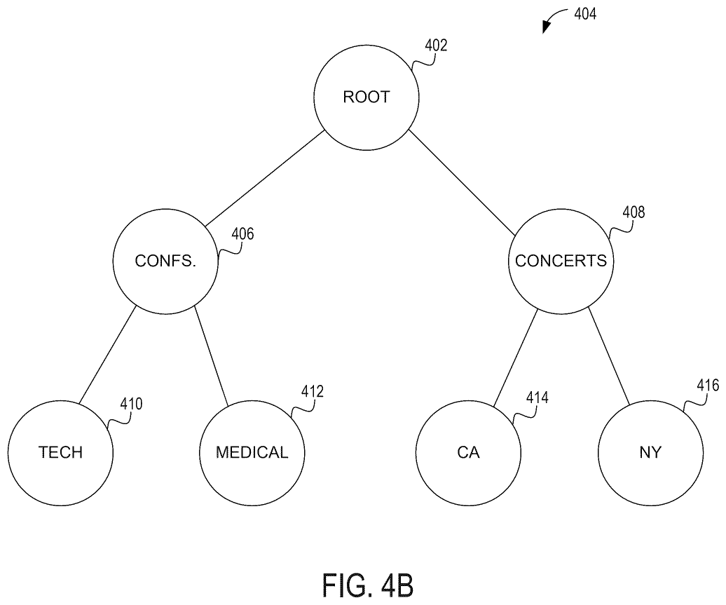

Furthermore, the architecture 300 of FIG. 3 provides efficient subscription matching for the fanout within the watch server 302. The efficient matching is performed, by the subscription matching and signaling component 318, using a prefix tree with hierarchical kind/parent matching criteria. The process of using the prefix tree will be discussed in connection with FIG. 4.

Finally, the architecture 300 of FIG. 3 provides efficient transport to client subscriptions 324, 326. Specifically, explicit logical subscription multiplexing is used to generate a single stream (e.g., GRCP stream) that can batch and compress data across multiple subscriptions for the same client. The batching and compression can be made efficient by using a larger buffer containing events across a set of subscriptions for the client. In example embodiments, each watch event in the stream is tagged with a subscription identifier (ID). When a client receives the multiplexed stream, the client can demux the subscriptions based on the subscription ID.

FIG. 4A is a diagram illustrating a simplified prefix tree 400 used in subscription matching by the matching and signaling component 318, according to example embodiments. The prefix tree 400 is a data structure used to efficiently match and signal subscriptions based on hierarchical filter criteria. This structure is particularly useful in watch server architectures that need to handle a large number of subscriptions and events.

The prefix tree 400 is organized in a hierarchical manner, with nodes that each represent a particular filter criterion. The nodes are connected in a way that reflects a logical hierarchy of the criteria, which allows for structure navigation through the prefix tree. The prefix tree starts with a top node (e.g., root 402) that does not store any value, but acts as a foundation from which all other nodes branch out. Subsequent levels can represent specific criteria, with each lower node in the hierarchy being a more specific criteria than their parent node. It is noted that only top levels of the prefix tree 400 are shown in FIG. 4 and that any number of lower levels of the hierarchy can exist. Additionally, only two kind nodes and two parent nodes off of each kind node are shown. However, any number of kind nodes and parent nodes can be contemplated.

This hierarchy allows for efficient traversal and matching of events to subscriptions. The use of the prefix tree 400 also allows the architecture 300 to scale efficiently, supporting millions of subscriptions without significant performance degradation. The hierarchical nature of the tree enables the system to manage a large number of filter criteria and subscriptions with minimal overhead.

When a change event occurs, the watch server 302 extracts metadata from the change event, such as the kind and other relevant criteria. The prefix tree 400 is then traversed to identify nodes that match the change event's criteria. This traversal is efficient and often logarithmic in complexity, allowing the watch server 302 to quickly determine which subscriptions are relevant to the change event.

Each node in the prefix tree 400 is associated with a condition variable [CV] that represent watch subscriptions 320 waiting for events matching that node's criteria. When a match is found, the subscription matching and signaling component 318 signals only those watch subscriptions 320 that are relevant, reducing unnecessary processing and ensuring timely delivery of events. This means that the watch subscriptions 318 are effectively paused until an event that matches their criteria occurs.

The prefix tree 400 is updated dynamically as subscriptions are added or removed. When a new subscription is created, nodes corresponding to its filter criteria are added to the tree. Conversely, when a subscription is removed, the associated nodes are updated or pruned as necessary.

FIG. 4B provides an example simplified prefix tree 404. Branching out from the root node 402 are kinds or types that include a conferences node 406 and a concerts node 408. Branching out from the conference node 406 can be nodes that represent types of conferences (e.g., tech node 410, medical node 412), while branching out from the concerts node 408 are locations of concerts (e.g., California node 414, New York node 416). It is noted that there can be more kind nodes as well as more nodes for conference types and concert locations. Additionally, each of the conference type and concert locations can have child nodes. For example, the tech node 410 can have child nodes that represent sub-types. For instance, the tech node 410 can have child nodes for developer conferences, cybersecurity conferences, consumer electronic shows, AI conferences, and so forth. These child nodes can have further lower levels of nodes such as, for example, location nodes or date range nodes.

In example embodiments, the subscription matching and signaling component 318 filters using the prefix tree. As examples, various watch sessions can watch for all concerts in NY, all medical conferences, or all medical conferences in the USA. The subscription matching and signaling component 318 traverses the prefix tree to reach these nodes and identify the corresponding watch subscriptions.

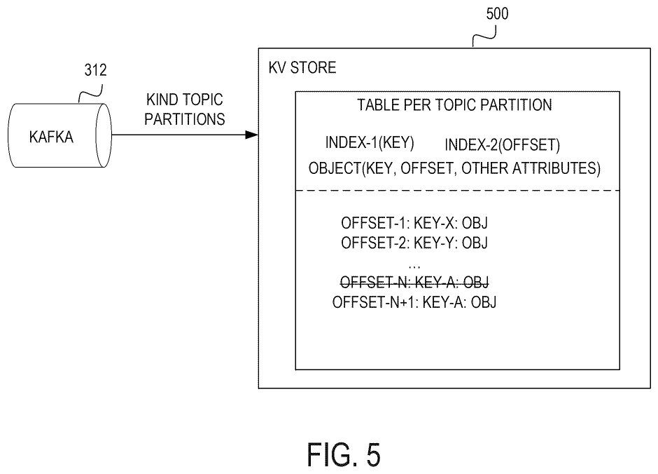

FIG. 5 is a diagram of a key-value store 500 with an offset index, according to example embodiments. As shown, change events are streamed by kind topic partitions to KV store 500 (e.g., via a Kafka consumer in a watch server). In the embodiment of FIG. 5, the KV store 500 serves as a unified data structure that supports both a primary state (e.g., the snapshot) and the change events (that are stored in the compacted queue 314). By using the KV store 500, the compacted queue 314 in FIG. 3 is not necessary and can be removed.

In example embodiments, the KV store 500 is indexed by both key and offset, allowing it to efficiently serve two types of queries: snapshots and change events. More specifically, the KV store 500 comprises a table for each topic in Kafka. This partitioning allows the watch server to manage data more effectively by segregating it based on specific topics or kinds. Each partition corresponds to a distinct category of data, facilitating targeted data processing and retrieval.

The table is indexed by both key and offset. By indexing data by a key, the KV store 500 can quickly access a latest state of objects for snapshot requests. As such, the table can efficiently serve list queries that provide the current state of data for watch subscriptions. Similarly, by indexing data by offset, the KV store 500 can efficiently retrieve a latest state of objects that have changed after a given offset. This indexing allows for implementing compacted queue functionality in the KV store 500, enabling the watch server to provide real-time updates to clients without having a compacted queue (e.g., compacted queue 314). In example embodiments, only the latest object state is retained with the latest offset.

Additionally, by maintaining separate tables for each topic partition, the KV store 500 can efficiently manage both snapshots and change events. This dual capability ensures that clients receive accurate and timely data, whether the clients are initiating a new subscription or monitoring ongoing changes. Furthermore, by organizing data into partitions and indexing it effectively, the watch server can scale to accommodate a growing number of watch sessions and client subscriptions without significant performance degradation.

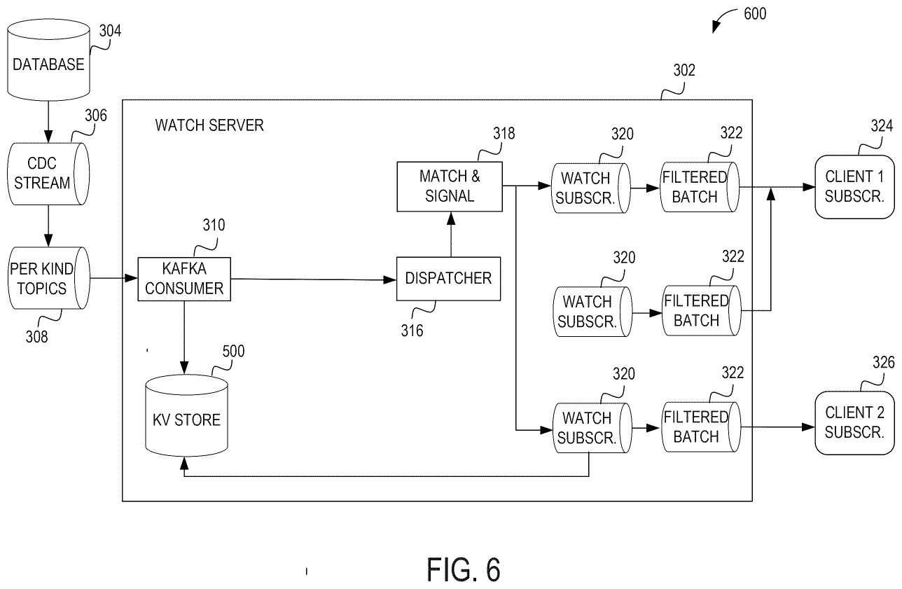

FIG. 6 is a diagram illustrating an example architecture 600 for highly scalable watches without a compacted queue, according to example embodiments. The architecture 600 is an alternative to the architecture 300 of FIG. 3. By integrating the functions of the compacted queue (e.g., compacted queue 314) into the KV store 500 as discussed in FIG. 5, a separate compacted queue is no longer needed. Instead, the KV store 500 manages both the primary state (e.g., snapshot) and the compacted queue functions (e.g., retaining latest change events). As a result, the watch subscription 320 can request both the snapshot and the change events from a current offset from the KV store 500. The snapshot is first retrieved from the KV store 500 during start up and the change events can be requested via an API call to the KV store 500. The dispatcher 316 manages distribution of requested data to the watch subscription 320 that made the API call. Each snapshot items has an offset associated with it. With a complete snapshot, the watch subscription 320 knows exactly where to jump into the event stream given a last offset from the snapshot.

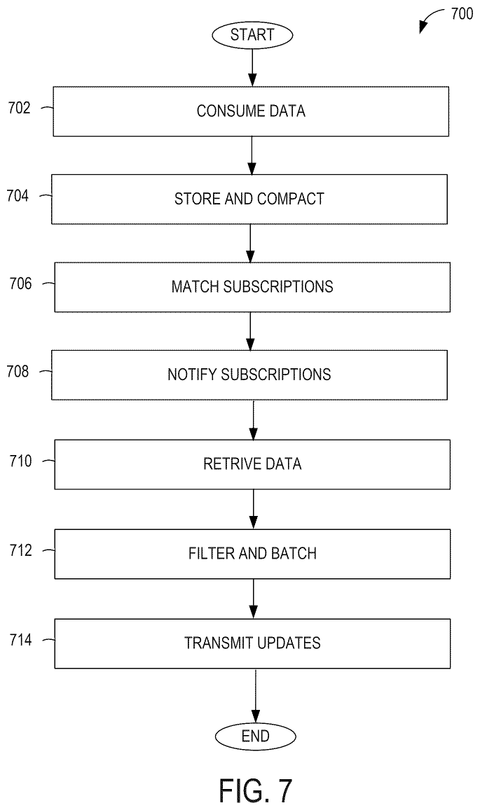

FIG. 7 is a flowchart of a method 700 for managing real-time data changes and client subscriptions, according to example embodiments. Operations in the method 700 may be performed by the components in the architecture 600 described above with respect to FIG. 3 and FIG. 6. Accordingly, the method 700 is described by way of example with reference to components in the architecture 600. However, it shall be appreciated that at least some of the operations of the method 700 may be deployed on various other hardware configurations or be performed by similar components. Therefore, the method 600 is not intended to be limited to these components.

Initially, a client initiates a watch session by subscribing to specific kinds and attributes. A subscription defines the criteria and parameters for monitoring data changes. The subscription can indicate a data type or kind the client is interested in (e.g., country or user). The subscription can also indicate filter criteria which defines specific conditions or attributes that the data must meet to be included (e.g., users with a name starting with “A”). If the subscription is not new, the subscription can indicate a current offset which indicates a position in the data stream from which the subscription last retrieved events.

In operation 702, a Kafka consumer 310 consumes data at the watch server 302. Change events are captured from the database 304 via the CDC stream 306 and organized into per kind topics 308 (e.g., in per kind topic partitions). The Kafka consumer 310 consumes the data from the per kind topics 308.

In operation 704, the data is stored and compacted at the KV store 500. Thus, both snapshots and real-time change events consumed by the Kafka consumer 310 are stored in the KV store 500. In example embodiments, the KV store 500 indexes the data by key and offset, as discussed in connection with FIG. 5. The KV store 500 also implements a “compacted queue” by retaining only a latest state of each object. This compaction process ensures that redundant historical data is eliminated, optimizing storage and retrieval.

In operation 706, the match and signal component 318 matches the change events from the data with subscriptions. In example embodiments, the match and signal component 318 traverses the prefix tree discussed in FIG. 4 to identify which subscriptions are interested in a particular event.

In operation 708, the matched watch subscriptions are notified. In example embodiments, once the relevant subscriptions are identified in operation 706, the match and signal component 318 signals the condition variables associated with those subscriptions. The signal can include an indication of a maximum offset. This signaling process wakes up the waiting watch subscriptions, indicating that there is a new event that matches their criteria.

In operation 710, the watch subscriptions retrieve the relevant data. In example embodiments, the watch subscription 320 makes an API call (e.g., GetObjects(from_offset) API call) to retrieve the latest changes from the KV store 500. The retrieved data is then distributed by the dispatcher 316 to the watch subscription 320.

In operation 712, the watch server 302 filters the retrieved data and batches the filtered data. In some cases, the filter criteria is applied, at this phase, to the retrieved data in order to narrow down on the data that the client is interested in. A multiplexed stream can be generated across multiple subscriptions for the same client. In example embodiments, each watch event in the multiplexed stream is tagged with a subscription identifier (subscription ID). When the client receives the multiplexed streams, it can demux the subscriptions based on the subscription ID. The multiplexed stream of updates is then transmitted to the client in operation 714.

While example embodiments have been described in which the watch server comprises a single service, alternative embodiments can contemplate have two microservices perform the operations within the watch server. For example, a first microservice can perform the caching and comprises the Kafka consumer 310, the KV store 312, 500, and if needed, the compacted queue 314. The second microservice is a subscription microservice that performs the watch operations and can comprise the dispatcher 316, the matching and signaling component 318, the watch subscriptions 320 and the filtered batch 322.

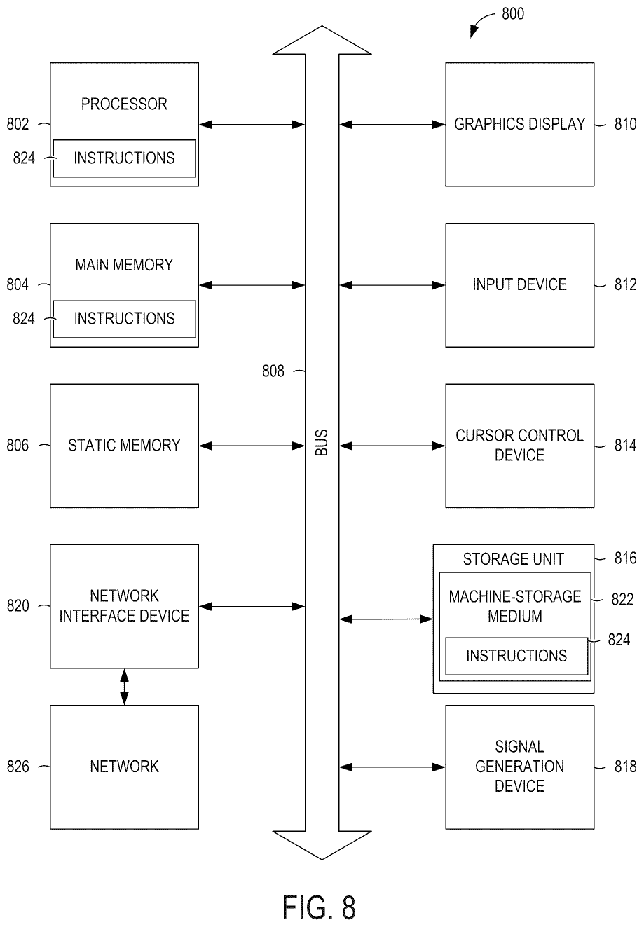

FIG. 8 illustrates components of a machine 800, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 8 shows a diagrammatic representation of the machine 800 in the example form of a computer device (e.g., a computer) and within which instructions 824 (e.g., software, a program, an application, an applet, an app, or other executable code) for causing the machine 800 to perform any one or more of the methodologies discussed herein may be executed, in whole or in part.

For example, the instructions 824 may cause the machine 800 to execute some or all of the diagrams and the flowchart of FIG. 7. In one embodiment, the instructions 824 can transform the machine 800 into a particular machine (e.g., specially configured machine) programmed to carry out the described and illustrated functions in the manner described.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more components described herein.

The machine 800 may further include a graphics display 810 (e.g., a plasma display panel (PDP), a light emitting diode (LED) display, a liquid crystal display (LCD), a projector, or a cathode ray tube (CRT), or any other display capable of displaying graphics or video). The machine 800 may also include an input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a sound card, an amplifier, a speaker, a headphone jack, or any suitable combination thereof), and a network interface device 820.

The storage unit 816 includes a machine-storage medium 822 (e.g., a tangible machine-storage medium) on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered as machine-storage media (e.g., tangible and non-transitory machine-storage media). The instructions 824 may be transmitted or received over a network 826 via the network interface device 820.

In some example embodiments, the machine 800 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 804, 806, and/or memory of the processor(s) 802) and/or storage unit 816 may store one or more sets of instructions and data structures (e.g., software) 824 embodying or utilized by any one or more of the methodologies or functions described herein. These instructions, when executed by processor(s) 802 cause various operations to implement the disclosed embodiments.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 822 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 822 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 may further be transmitted or received over a communications network 826 using a transmission medium via the network interface device 820 and utilizing any one of a number of well-known transfer protocols (e.g., HTTP). Examples of communication networks 826 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### Examples

Example 1 is a method for providing highly scalable real-time watch sessions. The method comprises consuming, by a watch server, change events from Kafka topics and a snapshot of a current state from a database; locally caching the change events and the snapshot at the watch server, the locally caching removing a need to consume from the Kafka topics and database for every watch subscription associated with the watch server; matching, by the watch server, the change events to watch subscriptions using a prefix tree reflecting hierarchical subscription filter criteria; signaling, by the watch server, a matching watch subscription by transmitting a signal that includes a maximum offset associated with the change events; in response to an API call from the matching watch subscription for the change events, providing the change events to the matching watch subscription; aggregating multiple change events including the change event into a batch; and transmitting the batch as a data stream to a client associated with the matching watch subscription.

In example 2, the subject matter of example 1 can optionally include wherein the transmitting comprises transmitting a multiplexed data stream that combines the data stream with one or more other data streams to be sent to the client; and each change event in the multiplexed data stream is tagged with a subscription identifier for the watch subscription that corresponds to each change event.

In example 3, the subject matter of any of examples 1-2 can optionally include wherein the locally caching comprises storing the snapshot in a key-value store; and storing the change events in a compacted queue that compacts multiple versions of an object associated with a change event and retains only a most recent version.

In example 4, the subject matter of any of examples 1-3 can optionally include wherein the locally caching comprises storing the snapshot and the change events in a key-value store using an offset index.

In example 5, the subject matter of any of examples 1-4 can optionally include wherein the storing comprises indexing a latest state of each object from the snapshot using a key; and indexing a latest state of each object that has changed using an offset.

In example 6, the subject matter of any of examples 1-5 can optionally include wherein the storing further comprises compacting the change events to retain only a most recent version per object.

In example 7, the subject matter of any of examples 1-6 can optionally include wherein each node in the prefix tree is associated with condition variables that represent watch subscriptions waiting for events matching criteria of each node.

In example 8, the subject matter of any of examples 1-7 can optionally include wherein the matching comprises traversing the prefix tree to identify a node having criteria that matches the change events.

In example 9, the subject matter of any of examples 1-8 can optionally include dynamically updating the prefix tree based on an addition or removal of a watch subscription.

In example 10, the subject matter of any of examples 1-9 can optionally include receiving the API call, the API call including a current offset of the matching watch subscription from which to provide the change events.

In example 11, the subject matter of any of examples 1-10 can optionally include wherein the consuming is performed by a single consumer in the watch server that consumers for all watch subscriptions associated with the watch server.

Example 12 is a system for providing highly scalable real-time watch sessions. The system comprises one or more processors and a memory storing instructions that, when executed by the one or more processors, cause the one or more processors to perform operations comprising consuming, by a watch server, change events from Kafka topics and a snapshot of a current state from a database; locally caching the change events and the snapshot at the watch server, the locally caching removing a need to consume from the Kafka topics and database for every watch subscription associated with the watch server; matching, by the watch server, the change events to watch subscriptions using a prefix tree reflecting hierarchical subscription filter criteria; signaling, by the watch server, a matching watch subscription by transmitting a signal that includes a maximum offset associated with the change events; in response to an API call from the matching watch subscription for the change events, providing the change events to the matching watch subscription; aggregating multiple change events including the change event into a batch; and transmitting the batch as a data stream to a client associated with the matching watch subscription.

In example 13, the subject matter of example 12 can optionally include wherein the transmitting comprises transmitting a multiplexed data stream that combines the data stream with one or more other data streams to be sent to the client; and each change event in the multiplexed data stream is tagged with a subscription identifier for the watch subscription that corresponds to each change event.

In example 14, the subject matter of any of examples 12-13 can optionally include wherein the locally caching comprises storing the snapshot in a key-value store; and storing the change events in a compacted queue that compacts multiple versions of an object associated with a change event and retains only a most recent version.

In example 15, the subject matter of any of examples 12-14 can optionally include wherein the locally caching comprises storing the snapshot and the change events in a key-value store using an offset index, the storing comprising indexing a latest state of each object from the snapshot using a key; and indexing a latest state of each object that has changed using an offset.

In example 16, the subject matter of any of examples 12-15 can optionally include wherein each node in the prefix tree is associated with condition variables that represent watch subscriptions waiting for events matching criteria of each node.

In example 17, the subject matter of any of examples 12-16 can optionally include wherein the matching comprises traversing the prefix tree to identify a node having criteria that matches the change events.

In example 18, the subject matter of any of examples 12-17 can optionally include wherein the operations further comprise receiving the API call, the API call including a current offset of the matching watch subscription from which to provide the change events.

In example 19, the subject matter of any of examples 12-18 can optionally include wherein the consuming is performed by a single consumer in the watch server that consumers for all watch subscriptions associated with the watch server.

Example 20 is a machine-storage medium comprising instructions which, when executed by one or more processors of a machine, cause the machine to perform operations for providing highly scalable real-time watch sessions. The operations comprise consuming, by a watch server, change events from Kafka topics and a snapshot of a current state from a database; locally caching the change events and the snapshot at the watch server, the locally caching removing a need to consume from the Kafka topics and database for every watch subscription associated with the watch server; matching, by the watch server, the change events to watch subscriptions using a prefix tree reflecting hierarchical subscription filter criteria; signaling, by the watch server, a matching watch subscription by transmitting a signal that includes a maximum offset associated with the change events; in response to an API call from the matching watch subscription for the change events, providing the change events to the matching watch subscription; aggregating multiple change events including the change event into a batch; and transmitting the batch as a data stream to a client associated with the matching watch subscription.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

1. A method for providing highly scalable real-time watch sessions, the method comprising:
consuming, by a watch server, change events from Kafka topics and a snapshot of a current state from a database;
locally caching the change events and the snapshot at the watch server, the locally caching removing a need to consume from the Kafka topics and database for every watch subscription associated with the watch server;
matching, by the watch server, the change events to watch subscriptions using a prefix tree reflecting hierarchical subscription filter criteria;
signaling, by the watch server, a matching watch subscription by transmitting a signal that includes a maximum offset associated with the change events;
in response to an API call from the matching watch subscription for the change events, providing the change events to the matching watch subscription;
aggregating multiple change events including the change event into a batch;
multiplexing a plurality of logical data streams associated with a plurality of watch subscriptions to generate a single multiplexed data stream indicative of the batch, wherein the single multiplexed data stream compresses data across the plurality of watch subscriptions; and
transmitting the multiplexed data stream indicative of the batch to a client associated with the matching watch subscription.

2. The method of claim 1, wherein:
each change event in the multiplexed data stream is tagged with a subscription identifier for the watch subscription that corresponds to each change event.

3. The method of claim 1, wherein the locally caching comprises:
storing the snapshot in a key-value store; and
storing the change events in a compacted queue that compacts multiple versions of an object associated with a change event and retains only a most recent version.

4. The method of claim 1, wherein the locally caching comprises storing the snapshot and the change events in a key-value store using an offset index.

5. The method of claim 4, wherein the storing comprises:
indexing a latest state of each object from the snapshot using a key; and
indexing a latest state of each object that has changed using an offset.

6. The method of claim 4, wherein the storing further comprises compacting the change events to retain only a most recent version per object.

7. The method of claim 1, wherein each node in the prefix tree is associated with condition variables that represent watch subscriptions waiting for events matching criteria of each node.

8. The method of claim 1, wherein the matching comprises traversing the prefix tree to identify a node having criteria that matches the change events.

9. The method of claim 1, further comprising:
dynamically updating the prefix tree based on an addition or removal of a watch subscription.

10. The method of claim 1, further comprising:
receiving the API call, the API call including a current offset of the matching watch subscription from which to provide the change events.

11. The method of claim 1, wherein the consuming is performed by a single consumer in the watch server that consumers for all watch subscriptions associated with the watch server.

12. A system for providing highly scalable real-time watch sessions, the system comprising:
one or more processors; and
a memory storing instructions that, when executed by the one or more processors, cause the one or more hardware processors to perform operations comprising:
consuming, by a watch server, change events from Kafka topics and a snapshot of a current state from a database;
locally caching the change events and the snapshot at the watch server, the locally caching removing a need to consume from the Kafka topics and database for every watch subscription associated with the watch server;
matching, by the watch server, the change events to watch subscriptions using a prefix tree reflecting hierarchical subscription filter criteria;
signaling, by the watch server, a matching watch subscription by transmitting a signal that includes a maximum offset associated with the change events;
in response to an application programming interface (API) call from the matching watch subscription for the change events, providing the change events to the matching watch subscription;
aggregating multiple change events including the change event into a batch;
multiplexing a plurality of logical data streams associated with a plurality of watch subscriptions to generate a single multiplexed data stream indicative of the batch, wherein the single multiplexed data stream compresses data across the plurality of watch subscriptions; and
transmitting the multiplexed data stream indicative of the batch to a client associated with the matching watch subscription.

13. The system of claim 12, wherein:
each change event in the multiplexed data stream is tagged with a subscription identifier for the watch subscription that corresponds to each change event.

14. The system of claim 12, wherein the locally caching comprises:
storing the snapshot in a key-value store; and
storing the change events in a compacted queue that compacts multiple versions of an object associated with a change event and retains only a most recent version.

15. The system of claim 12, wherein the locally caching comprises storing the snapshot and the change events in a key-value store using an offset index, the storing comprising:
indexing a latest state of each object from the snapshot using a key; and indexing a latest state of each object that has changed using an offset.

16. The system of claim 12, wherein each node in the prefix tree is associated with condition variables that represent watch subscriptions waiting for events matching criteria of each node.

17. The system of claim 12, wherein the matching comprises traversing the prefix tree to identify a node having criteria that matches the change events.

18. The system of claim 12, wherein the operations further comprise:
receiving the API call, the API call including a current offset of the matching watch subscription from which to provide the change events.

19. The system of claim 12, wherein the consuming is performed by a single consumer in the watch server that consumers for all watch subscriptions associated with the watch server.

20. A machine-storage medium comprising instructions which, when executed by one or more processors of a machine, cause the machine to perform operations for providing highly scalable real-time watch sessions, the operations comprising,
consuming, by a watch server, change events from Kafka topics and a snapshot of a current state from a database;
locally caching the change events and the snapshot at the watch server, the locally caching removing a need to consume from the Kafka topics and database for every watch subscription associated with the watch server;
matching, by the watch server, the change events to watch subscriptions using a prefix tree reflecting hierarchical subscription filter criteria;
signaling, by the watch server, a matching watch subscription by transmitting a signal that includes a maximum offset associated with the change events;
in response to an application programming interface (API) call from the matching watch subscription for the change events, providing the change events to the matching watch subscription;
aggregating multiple change events including the change event into a batch; and
multiplexing a plurality of logical data streams associated with a plurality of watch subscriptions to generate a single multiplexed data stream indicative of the batch, wherein the single multiplexed data stream compresses data across the plurality of watch subscriptions; and
transmitting the multiplexed data stream indicative of the batch to a client associated with the matching watch subscription.
